(19) United States
(12) Patent Application Publication
(10) Pub. No.: US 2003/0122724 A1
(43) Pub. Date: Jul. 3, 2003

(54) Planar array antenna

(76) Inventors: Martin William Shelley, Hampshire (GB); Francisco Javier Vazquez Sanchez, London (GB)

Correspondence Address: Baker & Daniels, Suite 800, 111 East Wayne Street, Fort Wayne, IN, 46802, US

(21) Appl. No.: 10/257,627

(22) PCT Filed: Apr. 9, 2001
(86) PCT No.: PCT/EP01/04041

(30) Foreign Application Priority Data
Apr. 18, 2000 (EP) 00303284.4

(51) Int. Cl. H01Q 13/00

(52) U.S. Cl. 343/786; 343/772

(57) ABSTRACT

A flat plate or slab antenna (1) is fabricated from a number of sandwiched layers in which a number of arrayed individual antenna elements (3) are formed. The antenna elements (3) each include a horn (12) with a rectangular aperture (13) feeding (or fed by) individual rectangular waveguides (15). Two orthogonal probes (17,20) protrude into each waveguide (13), each of which is connected to respective beamforming networks. The network of first probes (17) operates at a first frequency while the network of second probes (20) operates at a frequency which is different from the first frequency. In the preferred embodiment, the edges (13) of the horn apertures (12) are parallel to the sides (6, 7, 8, 9) of the antenna slab while the walls of the rectangular waveguides are at 45° to the sides (6, 7, 8, 9) of the slab. The antenna (1) is able to receive and/or transmit two orthogonally linearly polarised signal at different frequencies and is therefore capable of full duplex operation. Various additional features are also described which reduce coupling between the first (17) and second (20) probes, improve isolation between receiving and transmitting sections and maximise power dissipation within the structure.

### FIELD OF THE INVENTION

This invention relates to antennas and more particularly, though not solely, to planar array antennas.

### BACKGROUND TO THE INVENTION

Planar array antennas are well known. An example is disclosed in U.S. Pat. No. 4,527,165 which is formed from a sandwich construction of five layers. The layers include a first metal-coated insulating layer having a number of arrayed miniature horns and two further metal-coated insulating layers in which miniature waveguides are formed, aligned with the miniature horns. Each of the insulating layers is substantially the same thickness. The adjacent faces of the insulating layers are separated by thin dielectric film layers carrying conductive tracks, each dielectric film layer including a network of probes which is aligned in parallel, with one probe from each of the networks protruding into each of the antenna elements. The probes of the first dielectric film layer are aligned perpendicular to the probes of the second dielectric film layer. The elements in the antenna are designed to transmit/receive the two orthogonal components of a circularly polarised high frequency signal. The signals received from the antenna elements are subsequently combined in order to extract the circularly polarised signal.

It is also known that a uniformly excited array antenna, such as the one disclosed in U.S. Pat. No. 4,527,165, containing a number of rows and columns of elements has relatively high sidelobes in the planes of the rows and columns (the principle planes) but low sidelobes in the diagonal (or inter-cardinal) planes. It is further known that such an array can exhibit undesirable grating lobes in the principle planes and inter-cardinal planes if the elements exceed a certain electrical size. The grating lobes are produced in the principle planes when the antenna elements are greater than one wavelength across at the operating frequency and appear in the inter-cardinal planes when the element size exceeds approximately 1.4 wavelengths at the operating frequency.

Furthermore, the array antenna described above is incapable of multi-band operation and is physically rather thick, making it unsuitable in many situations.

### DISCLOSURE OF THE INVENTION

It is therefore an object of the present invention to provide a planar array antenna which goes at least some way towards overcoming the above disadvantages.

In a first aspect, the invention consists in an antenna element comprising:

a horn having a central cavity and edges defining a substantially rectangular shaped aperture,

a substantially rectangular waveguide coaxial with and having an opening connected to the central cavity of the horn

a first probe provided within the rectangular waveguide for transmitting and/or receiving a first signal linearly polarised in a first direction, and

a second probe provided within the rectangular waveguide for transmitting and/or receiving a second signal linearly polarised in a second direction,

wherein the first and second signals have different operating frequencies, the first and second directions are orthogonal and the edges of the horn aperture are at an angle of 45° to the directions of polarisation of the first and second signals.

In a further aspect, the invention consists in a planar antenna array comprising:

an antenna having a number of antenna elements as described in the above paragraph arranged so that the polarisation directions of the first and second signals associated with each antenna element are aligned respectively with the polarisation directions of the first and second signals of each of the other antenna elements, and

first and second beam forming networks which include the first and second probes respectively.

### BRIEF DESCRIPTION OF THE DRAWINGS

Particular embodiments of the invention will now be described with reference to the accompanying drawings in which:

FIG. 1 is a plan view of one embodiment of an antenna element which forms part of a planar array antenna in accordance with an embodiment of the present invention,

FIG. 2 is a cross-sectional view of an alternative embodiment of the antenna element shown in FIG. 1,

FIG. 3 is a perspective view of a further alternative embodiment of the antenna element shown in FIG. 1,

FIG. 4 is a rear view of a planar array antenna including a number of antenna elements in accordance with the present invention,

FIG. 5 is a cross-sectional view through A-A of the planar array antenna of FIG. 6, and

FIGS. 6A and 6B are cross-sectional views showing alternative feeding arrangements for the phase array antenna of FIG. 4.

### DETAILED DESCRIPTION OF THE PREFERRED EMBODIMENTS

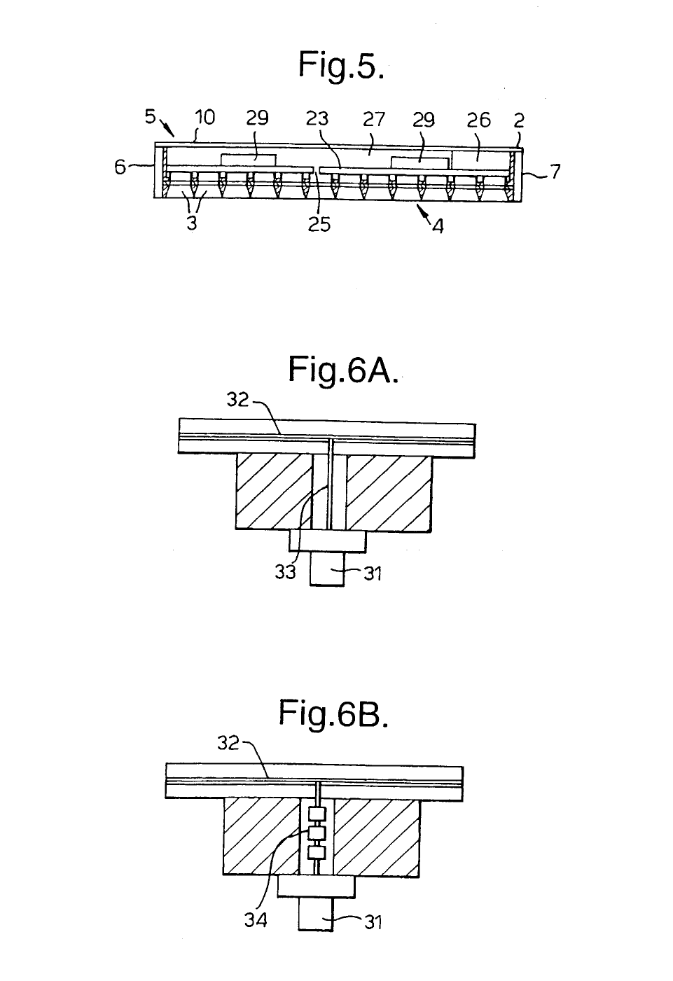

With reference to the Figures and in particular FIGS. 4 and 5, a planar array antenna 1 according to the present invention has a housing 2 within which an antenna made up of a number of individual antenna elements 3 is housed. The array antenna is formed as a slab or flat plate and has a front face 4, a rear face 5 (shown in plan in FIG. 4) and two pairs of substantially parallel sides 6,7 and 8,9. In the example shown in FIGS. 4 and 5 there are 144 individual antenna elements arranged in a lattice of 12 rows each containing 12 antenna elements. The overall dimensions of the array antenna could be, for example, 300 mm by 300 mm with a depth of for example 40 mm, including active transmit and receive components.

Although the antenna shown in the drawings has a generally square shape, it is intended that the antenna according to the invention could be any suitable shape in which rows of antenna elements are arrayed in rows at 45° to the principal planes of the antenna (that is, at 45° to the two directions of polarisation).

Preferably the housing is formed by injection moulding a plastics material such as ABS but could also be cast, for example, from a metal such as aluminium. A rear cover 10 (which has been removed in FIG. 4) which forms part of the antenna housing 2 is attached such as by screws or clips to the rear face of the array antenna and may also be formed from plastics or metal.

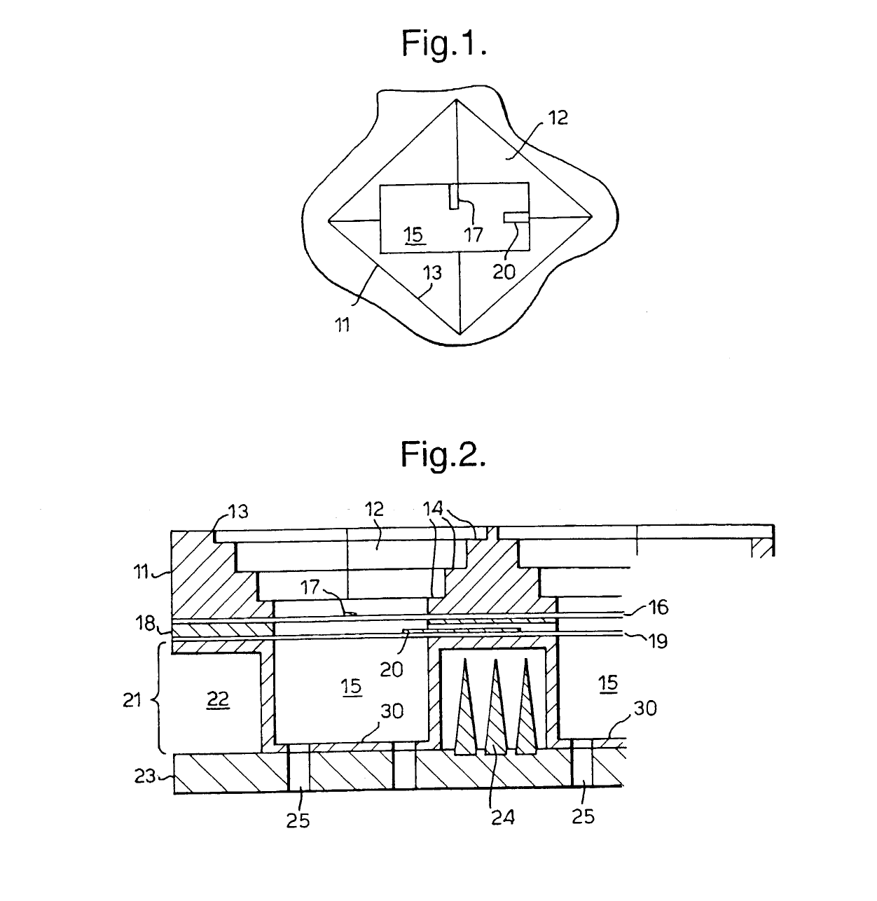

With reference now to FIGS. 1 and 2 which show respectively plan and cross-sectional views of a single one of the antenna elements of the array antenna, it can be seen that the antenna is formed from a number of separate layers which are sandwiched together and suitably connected to form a unitary member. A first layer 11 may be fabricated from an insulating material such as a plastics material which is metal coated or alternatively could be fabricated from a metal such as aluminium which has been cast or machined to provide a plate with central cavities forming a series of horns 12.

Each horn 12 has a generally rectangular (for example, square) shaped aperture 13 with a number of rectangular shaped steps 14 (shown in FIG. 2) providing an impedance match between free space and a waveguide, preferably substantially rectangular, at the base of each element. The walls of the waveguide are at 45° to the edges 13 of the horn aperture 12. The waveguide may include radiuses in each corner to aid manufacture. Alternatively, each of the sides of the aperture 13 may taper uniformly to the rectangular waveguide 15 (as shown in FIG. 1) or may taper to the rectangular waveguide 15 using a number of differing taper angles (that is, each of the internal sides of the horn cavity 12, extending from an edge of the horn aperture to meet the opening of the rectangular waveguide, may be made up of more than one planar segment, each of the segments being in different planes and therefore meeting at an angle). The thickness of the first layer 11 may, for example, be around 10 mm.

Beneath and directly adjacent to the first layer is a second layer 16. The second layer 16 carries a first beamforming network which includes a first probe 17 for each antenna element. The second layer may for example be a thin dielectric sheet onto which conductors are deposited, or alternatively may be a copper coated dielectric which is selectively etched to form the network of conductors making up the first beamforming network. For example, the dielectric could be a PTFE (polytetrafluoroethylene)-based or Polyimide substrate having a thickness of about 0.125 mm. As is well known, the beamforming network includes a number of probes used to excite the antenna elements. The probes are arranged on a substrate in a suitable manner in order to control reception or transmission of electromagnetic radiation.

A third layer 18 which, as with the first layer 11 may be fabricated from a metallised insulating material such as injection moulded plastics or cast or machined from aluminium or any other suitable metal, is beneath and directly adjacent to the second layer 16. The third layer 18 has essentially rectangular cavities provided in it which form a segment of the walls of the rectangular waveguide 15. Additional impedance matching features (not shown) may be provided on the walls of the cavities within the third layer 18. It can be seen in the example shown in FIG. 2 that the third layer is thinner than the first layer 11 and may, for example, be about 3 mm thick.

Directly beneath and adjacent to the third layer 18 is a fourth layer 19 which is preferably very similar in construction to the second layer 16. The fourth layer 19 is preferably also a thin dielectric sheet onto which conductors are deposited, or a copper coated dielectric which is selectively etched to form the electrical conductors of a second beamforming network. The second beamforming network includes a number of second probes 20 which extend into the rectangular waveguide 15 from a wall of the waveguide which is adjacent to the wall from which the first probe extends. Accordingly, the second probes extend in a direction which is perpendicular to the direction of the first probes. Preferably the first and second beamforming networks are formed as suspended striplines which are housed in channels in the first 11 and third 18 layers and the third 18 layer and fifth 21 layers respectively in the known way. The thickness of the fourth layer may, for example, be about 0.125 mm and the dielectric could be a PTFE-based or Polyimide substrate.

A fifth layer 21 which forms the bulk of the rectangular waveguide 15 is attached directly beneath and adjacent to the fourth layer 19. The fifth layer may also be fabricated from a metallised insulating material in common with the first 11 and third 18 layers or could be a suitable cast or machined metal. The fifth layer 21 consists of a series of “closed” or “open” cavities, forming the rear section of each antenna element. The “closed” cavities form a substantial part of the side walls and base 30 of the rectangular waveguide 15 and, when viewed from the rear of the array antenna, form a number of rectangular “posts”. The “open” cavities 22 form spaces between the “posts”.

Because the first 17 and second 20 probes are offset along the axis of the rectangular waveguide 15 and are designed to be impedance matched at different frequencies, a common short circuit may be used to match both of the probes into the rectangular waveguide. The common short circuit is provided by the base 30 of the rectangular waveguide.

A sixth layer 23 which is preferably a flat, heat conducting (preferably metal) plate is attached (for example by bonding or brazing) directly onto the posts of the fifth layer to provide good thermal contact there between. The sixth layer 23 forms a heat sink on to which heat producing electronic components of the array antenna may be mounted. Fins 24 which protrude from the surface of the heat sink and extend into the “open” cavities 22 formed in the fifth layer 21 may optionally be added to improve heat dissipation from the electronic components if required. The fins could be machined onto the plate or alternatively bonded or otherwise attached.

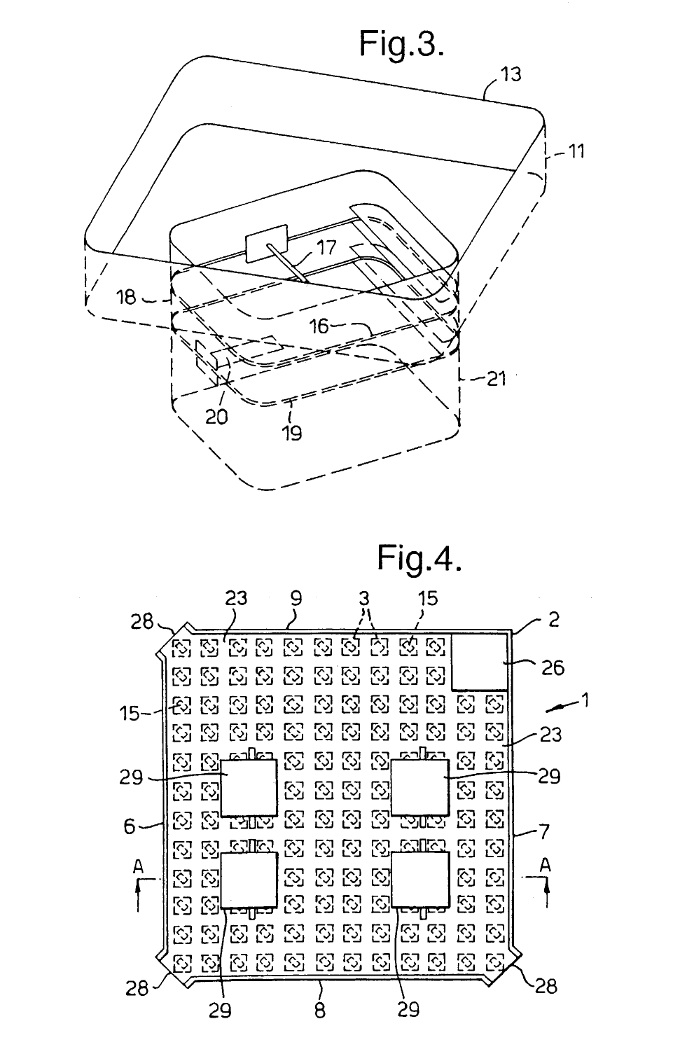

FIG. 3 shows a perspective view of a further alternative embodiment of the antenna element according to the present invention in which the horn 12 is not tapered or stepped but rather the walls of the internal cavity of the horn are perpendicular to the front and rear faces of the array antenna.

With reference once again to FIGS. 4 and 5, the rear cover 10 essentially forms a cavity 27 within the antenna structure. It can also be seen in FIG. 2 that aligned through holes 25 may be formed in the fifth and sixth layers (aligned holes, which are not shown, may also be formed in the second 16 and fourth 19 layers). This creates a common environment within the antenna 1 and housing 2. The holes 25 in the base 30 (for example, 4 holes per antenna element may be provided) provide a “virtual” common short circuit which still effectively impedance matches both of the probes to the rectangular waveguide.

A fan 26 which is mounted on the plate of the sixth layer 23 may be provided to draw air through a vent in the rear cover 10, into the “open” cavities 22 (through suitably positioned holes in plate 23) and out of the antenna via air vents 28, which may for example be provided at some or all of the corners of the housing 2. In cases where heat producing electronic components (such as high power amplifiers 29) are required as part of the antenna design, they may be attached in thermal contact to the plate 23 and be cooled by the heat sink and/or forced convection provided by the fan 26.

The antenna according to the embodiment shown in FIG. 4 may be thought of as being diamond shaped because in use the antenna is generally aligned with the antenna element diagonals in the horizontal and vertical planes.

It should be noted that the fifth 21 and sixth 23 plates could alternatively be manufactured as one layer.

In use, the first and second beamforming networks are connected to circuitry capable of either producing (for transmission by the antenna) or accepting (from the array antenna) respective first and second electrical signals which have been suitably modulated in a known way. The first probes 17 excite the waveguide 15 (or are excited by the waveguide) in a first operating frequency band having an operating wavelength λ₁ while the second probe 20 excites (or is excited by) the rectangular waveguide in a second operating frequency band which is higher than the first frequency band at an operating wavelength λ₂.

The planar array antenna of the present invention is suitable for receiving and/or transmitting in two different, orthogonal linearly polarised frequency bands. Furthermore, as the array antenna is designed to operate at two different frequencies, it is capable of full-duplex performance (that is, the antenna is capable of receiving and transmitting simultaneously). However, if preferred, both frequencies could be utilised as transmitting frequencies or both could be used as receiving frequencies. Preferably the antenna is oriented with the first probes 17 in a vertical plane and the second probes 20 in a horizontal plane, or vice versa, so that the antenna is capable of receiving and/or transmitting in these planes. Because the apertures 13 are arranged with their edges at 45° to the horizontal and vertical planes, the array antenna exhibits low sidelobes in these planes.

As an example, if the first probes were to operate at a frequency of around 11.4 to 12.7 GHz while the second probes were to operate at a frequency of around 14 to 14.5 GHz, then the radiating aperture can have dimensions of approximately 25 mm×25 mm, while the rectangular waveguide would preferably have dimensions (height by width as shown in FIG. 1) of 15.5 mm by 13 mm.

An important requirement of a full duplex system is to achieve high isolation between the transmitter and receiver sections of the antenna. The above described probe configuration may result in high levels of coupling between the first and second probes and consequent poor isolation and high levels of cross-polarisation. It is therefore preferred to use a balanced feeding structure for one or both of the beamforming networks. This could consist of balanced probes which are excited out-of-phase at the centre of the operating frequency band, a single probe and a balancing printed “dummy” probe or a balancing probe which is fabricated as part of the first, third or fifth layers. The balanced probes could be excited using a simple “T” power divider or, for improved broadband isolation, using a 180° hybrid coupler.

The present array antenna may also incorporate filters into the antenna feeding structure, either within the suspended stripline beamformers, or between the beamformers and connectors mounted on the rear of the antenna via which signals are communicated to/from the antenna.

Accordingly, in the first instance as shown in FIG. 6A, the suspended stripline tracks 32 between the antenna elements may be replaced, at least in some locations, with suspended stripline filter structures. In this example, a simple coaxial cable 33 may be connected between the connector 31 and the beamforming network.

In the second case, the coaxial cable 33 joining the connector 31 to the beamforming network may be replaced by a coaxial filter 34.

In order to minimise power losses associated with the beamforming structures, path lengths within the beamformers should be kept to a minimum. This is particularly critical at the transmit frequency, where the additional power dissipation associated with the need to use higher power output amplifiers can be critical to the thermal management of the array antenna, the battery lifetime (if the array antenna is battery operated) and filtering requirements.

Accordingly, a further improvement could be the use of one of the beamforming networks as a dedicated transmit beamformer which is subdivided into a number of sub-arrays (so that multiple external connectors are attached to the transmit beamforming network rather than a single output port), each of which is fed using a filter connection described above through individual power amplifiers 29 (see FIG. 4). The input to each of amplifiers 29 may be provided from a single driver amplifier (not shown) through a (less loss critical) power divider and suitable coaxial cabling or a secondary beamformer (not shown) mounted on the rear of the array antenna.

1. An antenna element (3) comprising:
a horn (12) having a central cavity and edges (13) defining a substantially rectangular shaped aperture,
a substantially rectangular waveguide (15) coaxial with and having an opening connected to the central cavity of the horn (12),
a first probe (17) provided within the rectangular waveguide (15) for transmitting and/or receiving a first signal linearly polarised in a first direction, and
a second probe (20) provided within the rectangular waveguide (15) for transmitting and/or receiving a second signal linearly polarised in a second direction,
wherein the first and second signals have different operating frequencies, the first and second directions are orthogonal and the edges (13) of the horn aperture (12) are at an angle of 45° to the directions of polarisation of the first and second signals.

2. An antenna element (3) as claimed in claim 1, wherein the central cavity of the horn (12) is stepped from the horn aperture (13) to the opening of the rectangular waveguide (15).

3. An antenna element (3) as claimed in claim 1, wherein the central cavity of the horn (12) tapers from the horn aperture (13) to the opening of the rectangular waveguide (15).

4. An antenna element (3) as claimed in any one of the preceding claims, wherein the first (17) and second (20) probes are balanced and connected to input/output sockets (31) of a “T” power divider or a 180° hybrid coupler.

5. A planar array antenna (1) comprising:
an antenna having a number of antenna elements (3) as claimed in any one of the preceding claims arranged so that the directions of polarisation of the first and second signals associated with each antenna element (3) are aligned respectively with the polarisation directions of the first and second signals of each of the other antenna elements (3), and
first and second beam forming networks which include the first (17) and second (20) probes respectively.

6. A planar array antenna (1) as claimed in claim 5, comprising a slab having front (4) and rear (5) substantially parallel planar surfaces and two pairs of substantially parallel side walls (6,7,8,9), the antenna elements (3) arranged with their horn apertures (12) formed in the front surface (4) so that each of the edges (13) of the horn apertures (12) are parallel with one or other of the pairs of side walls (6,7,8,9) of the antenna slab (1),
a heat conducting plate (23) forming the rear surface (5) of the antenna slab, at least part of the waveguides (15) of the antenna elements (3) protruding from the heat conducting plate (23), the heat conducting plate (23) forming a surface of cavities (22) in the antenna slab between the waveguides (12) of adjacent antenna elements (3) and,
wherein at least one heat producing electronic component (29) in the signal path of the planar array antenna (1) is placed in thermal contact with the heat conducting plate (23) which acts as a heat sink.

7. A planar array antenna (1) as claimed in claim 6, wherein cooling fins (24) are attached to the heat conducting plate (23), the cooling fins (24) projecting into at least some of the cavities (22) formed between the waveguides (12) of adjacent antenna elements (3).

8. A planar array antenna (1) as claimed in any one of claims 5 to 7, wherein at least parts of the first and second beam forming networks are formed from suspended strip line filter structures.

9. A planar array antenna (1) as claimed in any one of claims 5 to 8, wherein first and second electrical connectors (31) are provided on or adjacent to the rear surface (5) of the antenna slab to conduct the first and second signals respectively, wherein the first and second electrical connectors (31) are respectively connected to the first and second beam forming networks by first and second co-axial filters (34).

10. A planar array antenna (1) as claimed in any one of claims 5 to 9, wherein one of said first or second beam forming networks is a transmit only beam forming network and wherein a plurality of electrical connectors (31) are provided at or near the rear surface (5) of the antenna slab which are connected to said transmit only beam forming network by co-axial filters (34), each of which has an associated amplifier (29) connected thereto and in thermal contact with said heat conducting plate (23).
